(19) United States
(12) Patent Application Publication
(10) Pub. No.: US 2026/0135110 A1
(43) Pub. Date: May 14, 2026

(54) BINDER SOLUTION FOR ALL-SOLID-STATE BATTERY, ELECTRODE AND BATTERY USING THE SAME, AND METHOD FOR MANUFACTURING THE ELECTRODE AND THE BATTERY

(71) Applicant: ELECTRONICS AND TELECOMMUNICATIONS RESEARCH INSTITUTE, Daejeon (KR)

(72) Inventors: Jaecheol CHOI, Daejeon (KR); Young-Gi LEE, Daejeon (KR); Seok Hun KANG, Daejeon (KR); Ju Young KIM, Daejeon (KR); YOUNG SAM PARK, Daejeon (KR); Dong Ok SHIN, Daejeon (KR)

(21) Appl. No.: 19/302,599

(22) Filed: Aug. 18, 2025

(30) Foreign Application Priority Data
Nov. 12, 2024 (KR) 10-2024-0160423
Feb. 18, 2025 (KR) 10-2025-0020982

(51) Int. Cl. H01M 4/62; H01M 4/04; H01M 10/0525; H01M 10/0562

(52) U.S. Cl. CPC H01M 4/622; H01M 4/0404; H01M 10/0525; H01M 10/0562; H01M 2300/0068

(57) ABSTRACT

Provided is a binder solution for an all-solid-state battery, and a binder solution for an all-solid-state battery according to some embodiment of the inventive concept may include a solvent including anisole, and a binder including an acrylonitrile-butadiene rubber containing an acrylonitrile repeating unit and a butadiene repeating unit. The acrylonitrile repeating unit may amount to 31 to 35 parts by weight with respect to 100 parts by weight of the acrylonitrile-butadiene rubber.

### CROSS-REFERENCE TO RELATED APPLICATIONS

This U.S. non-provisional patent application claims priority under 35 U.S.C. § 119 of Korean Patent Application Nos. 10-2024-0160423, filed on Nov. 12, 2024, and 10-2025-0020982, filed on Feb. 18, 2025, the entire contents of which are hereby incorporated by reference.

### BACKGROUND

### 1. Field of the Invention

The present disclosure herein relates to a binder solution for all-solid-state battery, an electrode and a battery using the same, and a method for manufacturing the electrode and the battery.

### 2. Description of Related Art

Research is actively underway on polymers containing nitrile groups as binders for all-solid-state batteries, regarding chemical stability and ionic conductivity. When manufacturing all-solid-state batteries, binders are dissolved in a solvent and then mixed with other materials such as solid electrolytes and electrode active materials.

Typically, research has focused on dissolving polymers containing nitrile groups in nonpolar solvents such as xylene or toluene for use. However, when these polymers containing nitrile groups are dissolved in nonpolar solvents, polymer chains are distributed as aggregates, leading to a decrease in the mechanical properties of an electrode.

### SUMMARY

The present disclosure provides a binder solution for an all-solid-state battery in which a binder is evenly distributed.

The present disclosure provides a method for manufacturing an electrode for an all-solid-state battery capable of manufacturing an electrode exhibiting excellent mechanical properties.

The present disclosure provides a method for manufacturing an all-solid-state battery capable of manufacturing an all-solid-state battery exhibiting excellent output and lifespan characteristics.

The present disclosure provides an electrode for an all-solid-state battery exhibiting excellent mechanical properties.

The present disclosure provides an all-solid-state battery exhibiting excellent output and lifespan characteristics.

An embodiment of the inventive concept provides a binder solution for an all-solid-state battery, including a solvent including anisole, and a binder including an acrylonitrile-butadiene rubber containing an acrylonitrile repeating unit and a butadiene repeating unit. The acrylonitrile repeating unit amounts to about 31 to about 35 parts by weight with respect to 100 parts by weight of the acrylonitrile-butadiene rubber.

In some embodiments, the binder may amount to about 1 to about 10 parts by weight with respect to 100 parts by weight of the binder solution.

In some embodiments, the binder solution for an all-solid-state battery may have a viscosity of about 15 cPs to about 200 cPs.

In some embodiments, the acrylonitrile-butadiene rubber may have a weight average molecular weight of about 5,000 g/mol to about 10,000,000 g/mol.

In some embodiments, the binder may have an average domain size of about 15 μm to about 110 μm.

In an embodiment of the inventive concept, a method for manufacturing an electrode for an all-solid-state battery includes mixing a binder with a first solvent to prepare a binder solution, mixing the binder solution with a solid electrolyte material and an electrode active material to prepare a coating mixture, and applying the coating mixture onto a current collector to form a coating layer. The first solvent includes anisole. The binder includes an acrylonitrile-butadiene rubber containing an acrylonitrile repeating unit and a butadiene repeating unit. The acrylonitrile repeating unit amounts to about 31 to about 35 parts by weight with respect to 100 parts by weight of the acrylonitrile-butadiene rubber.

In some embodiments, the solid electrolyte material may include a sodium (Na) super ionic conductor (NASICON)-based solid electrolyte material, an oxide-based solid electrolyte material, a sulfide-based solid electrolyte material, or a polymer solid electrolyte material, or any one of combinations thereof.

In some embodiments, the solid electrolyte material may include lithium phosphorus sulfide (LPS), or lithium phosphorus sulfur chloride (LPSCl), or any one of combinations thereof.

In some embodiments, the electrode active material may be a negative electrode active material, and the negative electrode active material may include silicon, tin, graphite, or lithium, or any one of mixtures thereof.

In some embodiments, the electrode active material may be a positive electrode active material, and the positive electrode active material may include sulfur, LiCoO₂, LiNiO, LiNiₓCo_{y}Mn_{1-x-y}O, LiMnO₄, or LiFePO₄, or any one of mixtures thereof.

In some embodiments, the preparing of a coating mixture may further include mixing the binder solution, the solid electrolyte material, and the electrode active material with a second solvent. The second solvent may include anisole.

In some embodiments, in the preparing of a coating mixture, with respect to 100 parts by weight of a total of the binder, the solid electrolyte material, and the electrode active material, the electrode active material may amount to about 52.6 to about 98.5 parts by weight, the solid electrolyte material may amount to about 1 to about 42.1 parts by weight, and the binder may amount to about 0.5 to about 5.3 parts by weight.

In some embodiments, the preparing of a coating mixture may further include mixing the binder solution, the solid electrolyte material, and the electrode active material with a conductive material. The conductive material may include carbon black, carbon nanotube, or graphene, or any one of combinations thereof.

In some embodiments, in the preparing of an electrode coating mixture, with respect to 100 parts by weight of a total of the binder, the solid electrolyte, the electrode active material, and the conductive material, the electrode active material may amount to about 50 to about 98.5 parts by weight, the solid electrolyte material may amount to about 1 to about 40 parts by weight, the binder may amount to about 0.5 to about 5 parts by weight, and the conductive material may amount to greater than about 0 to about 5 parts by weight.

In an embodiment of the inventive concept, a method for manufacturing an all-solid-state battery includes forming a first electrode, attaching the first electrode to one surface of a solid electrolyte, and attaching a second electrode to the other surface of the solid electrolyte. The forming of a first electrode may include mixing a binder with a first solvent to prepare a binder solution, mixing the binder solution with a solid electrolyte material and an electrode active material to prepare an electrode coating mixture, and applying the electrode coating mixture onto a current collector to form an electrode coating layer. The first solvent includes anisole. The binder includes an acrylonitrile-butadiene rubber containing an acrylonitrile repeating unit and a butadiene repeating unit. The acrylonitrile repeating unit amounts to about 31 to about 35 parts by weight with respect to 100 parts by weight of the acrylonitrile-butadiene rubber.

In some embodiments, the solid electrolyte and the solid electrolyte material may include the same material.

In an embodiment of the inventive concept, an all-solid-state battery includes a first electrode, a second electrode spaced apart from the first electrode, and a solid electrolyte disposed between the first electrode and the second electrode. The first electrode includes a current collector, and a coating layer between the current collector and the solid electrolyte. The coating layer includes a solid electrolyte material, an electrode active material, a binder, and a conductive material. The binder includes an acrylonitrile-butadiene rubber containing an acrylonitrile repeating unit and a butadiene repeating unit. The acrylonitrile repeating unit amounts to about 31 to about 35 parts by weight with respect to 100 parts by weight of the acrylonitrile-butadiene rubber. In the coating layer, the binder has an average domain size of about 15 μm to about 110 μm.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a schematic view of a binder solution according to some embodiments of the inventive concept;

FIG. 2 is a cross-sectional view of an electrode for an all-solid-state battery according to some embodiments of the inventive concept;

FIG. 3 is a plan view of a coating layer from FIG. 2;

FIG. 4 is a cross-sectional view of an all-solid-state battery according to some embodiments of the inventive concept;

FIG. 5 shows a method for manufacturing an electrode for an all-solid-state battery according to some embodiments of the inventive concept;

FIG. 6 shows a method for manufacturing an all-solid-state battery according to some embodiments of the inventive concept;

FIG. 7A is a schematic view of a binder solution according to <Comparative Example 1-1>;

FIG. 7B is a schematic view of a binder solution according to <Comparative Example 1-2>;

FIG. 8 shows an average domain size of <Example 1>, <Comparative Example 1-1>, and <Comparative Example 1-2>;

FIG. 9 shows a viscosity of binder solutions of <Example 1>, <Comparative Example 1-1>, and <Comparative Example 1-2>;

FIG. 10A is a plan view of a coating layer of an electrode for an all-solid-state battery according to <Comparative Example 2-1>;

FIG. 10B is a plan view of a coating layer of an electrode for an all-solid-state battery according to <Comparative Example 2-2>;

FIG. 11 shows the results of measuring peel strength of electrodes according to <Example 2>, <Comparative Example 2-1>, and <Comparative Example 2-2>;

FIG. 12 shows the results of measuring peel strength of electrodes according to <Example 3>, <Comparative Example 3-1>, and <Comparative Example 3-2>;

FIG. 13 shows the results of measuring specific capacity of batteries according to <Example 4>, <Comparative Example 4-1>, and <Comparative Example 4-2> at an external pressure of about 48 MPa;

FIG. 14 shows the results of measuring Coulombic efficiency of batteries according to <Example 4>, <Comparative Example 4-1>, and <Comparative Example 4-2> at an external pressure of about 48 MPa;

FIG. 15 shows the results of measuring specific capacity of batteries according to <Example 4>, <Comparative Example 4-1>, and <Comparative Example 4-2> at a pressure of about 12 MPa;

FIG. 16 shows the results of measuring Coulombic efficiency of batteries according to <Example 4>, <Comparative Example 4-1>, and <Comparative Example 4-2> at an external pressure of about 48 MPa;

FIG. 17 shows the results of measuring voltage over time of <Experimental Example 4-3> of <Example 4>, <Comparative Example 4-1>, and <Comparative Example 4-2>;

FIG. 18 shows the results of measuring internal pressure over time of <Experimental Example 4-3> of <Example 4>, <Comparative Example 4-1>, and <Comparative Example 4-2>; and

FIG. 19 shows accumulated internal pressure change/capacity change values according to charge and discharge of Experimental Example 4-3> of <Example 4>, <Comparative Example 4-1>, and <Comparative Example 4-2>.

### DETAILED DESCRIPTION

In order to facilitate sufficient understanding of the configuration and effects of this disclosure, preferred embodiments of the disclosure will be described with reference to the accompanying drawings. However, the disclosure is not limited to the embodiments set forth below, and may be embodied in various forms and modified in many alternate forms. Rather, these embodiments are provided so that this disclosure will be thorough and complete, and will fully convey the scope of the disclosure to those skilled in the art to which the disclosure pertains. In the accompanying drawings, elements are shown enlarged from the actual size thereof for convenience of description, and the ratio of each element may be exaggerated or reduced.

Like reference numerals refer to substantially like elements throughout.

In the following description, detailed descriptions of components and functions known in the technical field of the disclosure may be skipped if they are not related to core components of the disclosure. The meanings of the terms described herein should be understood as follows.

Shapes, sizes, ratios, angles, numbers, and the like disclosed in the drawings of the disclosure are illustrative, so that the disclosure is not limited to the illustrated details.

In addition, in describing the disclosure, when it is determined that a detailed description of a related known technology may unnecessarily obscure the gist of the disclosure, the detailed description will be skipped.

When the terms ‘include,’ ‘have,’ ‘consist of,’ and the like are used herein, other parts may be added unless ‘only’ is used. Elements of a singular form may include elements plural forms unless the context clearly indicates otherwise.

In interpreting elements, it is to be construed as including an error range even if there is no separate explicit recitation.

When the description is of a positional relationship, e.g., when a positional relationship between two portions is described by ‘on˜,’ ‘upper˜,’ ‘lower˜,’ ‘next to˜,’ etc., one or more other portions may be disposed between the two portions unless ‘right’ or ‘directly’ is used.

When the description is of a temporal relationship, e.g., when a temporal antecedent relationship is described by ‘afterward,’ ‘after˜,’ ‘subsequent to˜,’ ‘following˜,’ ‘before˜,’ etc., it may also include a case of a non-continuous temporal relationship unless ‘immediately’ or ‘directly’ is used.

It will be understood that, although the terms ‘first,’ ‘second,’ etc., are used herein to describe various elements, these elements should not be limited by these terms. These terms are only used to distinguish one element from another.

Therefore, a first element mentioned hereinafter may be a second element within the technical spirit of the disclosure.

The term “at least one” should be understood as including all possible combinations from one or more related items. For example, the meaning of “at least one of a first item, a second item, and a third item” may mean not only the first item, the second item, or the third item itself, but also all possible combinations of items to be proposed from two or more of the first item, the second item, and the third item.

Hereinafter, preferred embodiments of the disclosure will be described in detail with reference to the accompanying drawings.

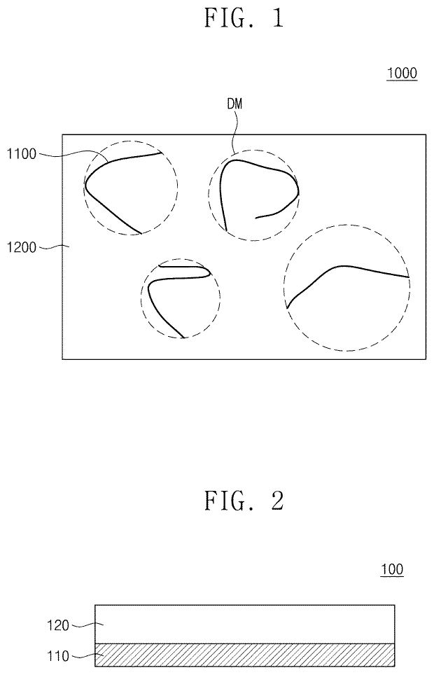

FIG. 1 is a schematic view of a bonder solution according to some embodiments of the inventive concept.

A binder solution 1000 according to some embodiments of the inventive concept may include a binder 1100 and a solvent 1200.

The binder 1100 may include an acrylonitrile-butadiene rubber. The acrylonitrile-butadiene rubber may have a weight average molecular weight of about 5,000 g/mol to about 10,000,000 g/mol. The acrylonitrile-butadiene rubber may include an acrylonitrile repeating unit and a butadiene repeating unit. The acrylonitrile repeating unit may amount to about 31 to about 35 parts by weight with respect to 100 parts by weight of the acrylonitrile-butadiene rubber, and the butadiene repeating unit may amount to about 65 to about 69 parts by weight with respect to 100 parts by weight of the acrylonitrile-butadiene rubber. When the acrylonitrile repeating unit amounts to about less than 31 parts by weight with respect to 100 weight parts of the acrylonitrile-butadiene rubber, an electrode manufactured from the binder solution 1000 may have reduced peel strength due to the low content of acrylonitrile repeating unit having polarity. When the acrylonitrile repeating unit amounts to greater than about 35 parts by weight with respect to 100 weight parts of the acrylonitrile-butadiene rubber, the binder 1100 may not dissolve well in the solvent 1200, resulting in reduced peel strength of an electrode manufactured from the binder solution 1000.

The binder 1100 may further include polyvinylidene fluoride (PVDF), styrene-butadiene rubber (SBR), or polyvinylpyrrolidone (PVP), or a combination thereof.

The binder 1100 may amount to about 1 to about 10 parts by weight with respect to 100 parts by weight of the binder solution 1000.

The solvent 1200 may include anisole. The solvent 1200 may amount to about 90 to about 99 parts by weight with respect to 100 parts by weight of the binder solution 1000.

In the binder solution 1000, the binder 1100 may be provided in the form of particles. Herein, a domain indicates a space in the form of a spherical particle, and a domain size indicates a diameter of the domain.

The binder solution 1000 according to FIG. 1 may gave a domain DM size of about 15 μm to about 110 μm. The binder solution 1000 may have a viscosity of about 15 cPs to about 200 cPs.

The binder solution 1000 according to some embodiments of the inventive concept may include a binder 1100 including an acrylonitrile-butadiene rubber in an amount of about 31 to about 35 parts by weight with respect to 100 parts by weight of the acrylonitrile-butadiene rubber, and a solvent 1200 including anisole. By allowing the solvent 1200 to include anisole suitable for an acrylonitrile-butadiene rubber binder having a polar acrylic group, and allowing the binder 1100 to include an acrylonitrile-butadiene rubber in an amount of about 31 to about 35 parts by weight suitable for anisole, a binder solution 1000 having a suitable average domain size and a suitable viscosity may be provided. Accordingly, an all-solid-state battery electrode exhibiting excellent mechanical properties and an all-solid-state battery exhibiting excellent initial implementation capacity and lifespan may be manufactured.

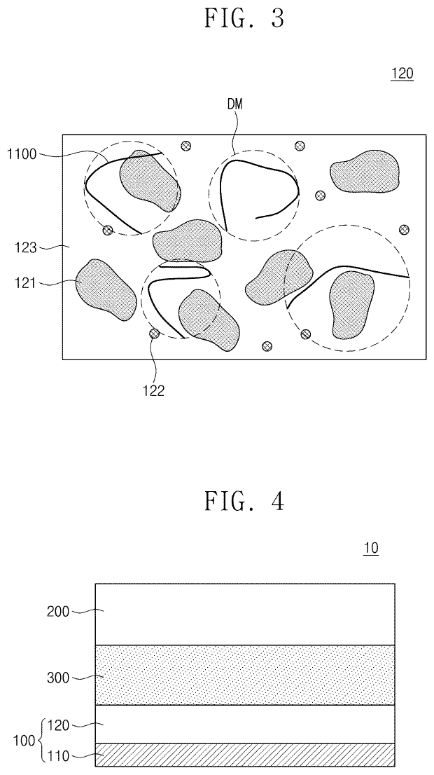

FIG. 2 is a cross-sectional view of an electrode for an all-solid-state battery according to some embodiments of the inventive concept. FIG. 3 is a plan view of a coating layer from FIG. 2.

Referring to FIGS. 2 and 3, an electrode 100 according to some embodiments of the inventive concept may include a current collector 110 and a coating layer 120.

The current collector 110 may include a metal such as nickel.

The coating layer 120 may include a binder 1100, an electrode active material 121, a conductive material 122, and a solid electrolyte material 123.

The description for the binder 1100 is the same as in FIG. 1, and the coating layer 120 may also have a domain DM size of about 15 μm to about 110 μm, as in the case of FIG. 1.

The electrode active material 121 may include a secondary battery electrode active material and may include a lithium secondary battery electrode active material. The electrode active material 121 may include a positive electrode active material and/or a negative electrode active material. The positive electrode active material may include, for example, sulfur, LiCoO, LiNiO, LiNiCoMnO, LiMnO, or LiFePO, or any one of mixtures thereof. The negative electrode active material may include silicon, tin, graphite, or lithium, or any one of mixtures thereof.

The conductive material 122 may include carbon black, carbon nanotube, or graphene, or any one of combinations thereof.

The solid electrolyte material 123 may include a sodium (Na) super ionic conductor (NASICON)-based solid electrolyte material, an oxide-based solid electrolyte material, a sulfide-based solid electrolyte material, or a polymer solid electrolyte material, or any one of combinations thereof. The NASICON-based solid electrolyte material may include NASICON-type LATP (Li_{1.3}Al_{0.3} Ti_{1.7}(PO₄)₃), or NASICON-type LAGP (Li_{1.5}Al_{0.5}Ge_{1.5}(PO₄)₃), or any one of combinations thereof. The oxide-based solid electrolyte material may include Garnet structure LLZO (Li₇La₃Zr₂O₁₂), perovskite-type LLTO (Li_{0.3}La_{0.57}TiO₃), or any one of combinations thereof. The sulfide-based solid electrolyte material may include lithium phosphorus sulfide (LPS), or lithium phosphorus sulfur chloride (LPSCl), or any one of combinations thereof. The polymer solid electrolyte material may include a solvent-free solid electrolyte material, or a gel solid electrolyte material, or any one of combinations thereof.

The coating layer 120 may include about 50 to about 98.5 parts by weight of the electrode active material 121 with respect to 100 parts by weight of the entire coating layer 120. The coating layer 120 may include about 1 to about 40 parts by weight of the solid electrolyte material 123 with respect to 100 parts by weight of the entire coating layer 120. The coating layer 120 may include about 0.5 to about 5 parts by weight of the binder 1100 with respect to 100 parts by weight of the entire coating layer 120. The coating layer 120 may include about 0 to about 5 parts by weight of the conductive material 122 with respect to 100 parts by weight of the entire coating layer 120.

The electrode 100 according to some embodiments of the inventive concept may include a binder 1100 including an acrylonitrile-butadiene rubber in an amount of about 31 to about 35 parts by weight with respect to 100 parts by weight of the acrylonitrile-butadiene rubber, and a coating layer 120. In addition, the coating layer 120 may have a domain DM size of about 15 μm to about 110 μm. By ensuring the coating layer 120 has an appropriate average domain size, an all-solid-state battery electrode exhibiting excellent mechanical properties may be provided.

FIG. 4 is a cross-sectional view of an all-solid-state battery according to some embodiments of the inventive concept.

An all-solid-state battery 10 according to some embodiments of the inventive concept may include a first electrode 100, a second electrode 200, and a solid electrolyte 300.

The description of the first electrode 100 is the same as the description of the electrode 100 in FIGS. 2 and 3.

The second electrode 200 may be spaced apart from the first electrode 100. When the first electrode 100 is a positive electrode, the second electrode 200 may be a negative electrode, and when the first electrode 100 is a negative electrode, the second electrode 200 may be a positive electrode. The configuration of the second electrode 200 may be the same as or different from the configuration of the electrode 100 in FIGS. 2 and 3.

A solid electrolyte 300 may be disposed between the first electrode 100 and the second electrode 200. The solid electrolyte 300 may include a NASICON-based solid electrolyte material, an oxide-based solid electrolyte material, a sulfide-based solid electrolyte material, or a polymer-based solid electrolyte material, or any one of combinations thereof. For example, the solid electrolyte 300 may include the same material as the solid electrolyte material 123 included in the first electrode 100.

The battery 10 according to some embodiments of the inventive concept may include an electrode 100 including a coating layer 120 having a binder 1100 containing an acrylonitrile-butadiene rubber in an amount of about 31 to about 35 parts by weight with respect to 100 parts by weight of the acrylonitrile-butadiene rubber. In addition, the coating layer 120 may have a domain DM size of about 15 μm to about 110 μm. By ensuring the coating layer 120 has an appropriate average domain size, an all-solid-state battery exhibiting excellent output characteristics and lifespan characteristics may be provided.

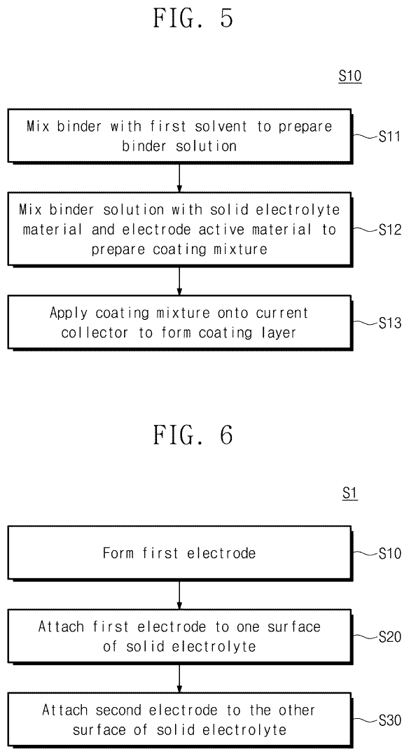

FIG. 5 shows a method for manufacturing an electrode for an all-solid-state battery according to some embodiments of the inventive concept.

Referring to FIG. 5, a method for manufacturing an electrode for an all-solid-state battery (S10) according to some embodiment of the inventive concept may include mixing a binder with a first solvent to prepare a binder solution (S11), mixing the binder solution with a solid electrolyte material and an electrode active material to prepare a mixture (S12), and applying the coating mixture onto a current collector to form a coating layer (S13).

The binder solution may be prepared by mixing a binder with a first solvent (S11).

The binder may include an acrylonitrile-butadiene rubber. The acrylonitrile-butadiene rubber may have a weight average molecular weight of about 5,000 g/mol to about 10,000,000 g/mol. The acrylonitrile-butadiene rubber may include an acrylonitrile repeating unit and a butadiene repeating unit. The acrylonitrile repeating unit may amount to about 31 to about 35 parts by weight with respect to 100 parts by weight of the acrylonitrile-butadiene rubber, and the butadiene repeating unit may amount to about 65 to about 69 parts by weight with respect to 100 parts by weight of the acrylonitrile-butadiene rubber. When the acrylonitrile repeating unit amounts to about less than 31 parts by weight with respect to 100 weight parts of the acrylonitrile-butadiene rubber, an electrode manufactured from the binder solution 1000 may have reduced peel strength due to the low content of acrylonitrile repeating unit having polarity. When the acrylonitrile repeating unit amounts to greater than about 35 parts by weight with respect to 100 weight parts of the acrylonitrile-butadiene rubber, the binder 1100 may not dissolve well in the solvent 1200, resulting in reduced peel strength of an electrode manufactured from the binder solution 1000.

The binder may further include polyvinylidene fluoride (PVDF), styrene-butadiene rubber (SBR), or polyvinylpyrrolidone (PVP), or a combination thereof.

The binder may be mixed in an amount of about 1 to about 10 parts by weight with respect to 100 parts by weight of the binder solution.

The solvent may include anisole. The solvent may be mixed in an amount of about 90 to about 99 parts by weight with respect to 100 parts by weight of the binder solution.

The binder solution may have a domain size of about 15 μm to about 110 μm. The binder solution may have a viscosity of about 15 cPs to about 200 cPs.

The formed binder solution may be mixed with a solid electrolyte material and an electrode active material to prepare a coating mixture (S12).

The solid electrolyte material may include a sodium (Na) super ionic conductor (NASICON)-based solid electrolyte material, an oxide-based solid electrolyte material, a sulfide-based solid electrolyte material, or a polymer solid electrolyte material, or any one of combinations thereof. The NASICON-based solid electrolyte material may include NASICON-type LATP (Li_{1.3}Al_{0.3} Ti_{1.7}(PO₄)₃), or NASICON-type LAGP (Li_{1.5}Al_{0.5}Ge_{1.5}(PO₄)₃), or any one of combinations thereof. The oxide-based solid electrolyte material may include Garnet structure LLZO (Li₇La₃Zr₂O₁₂), perovskite-type LLTO (Li_{0.3}La_{0.57}TiO₃), or any one of combinations thereof. The sulfide-based solid electrolyte material may include lithium phosphorus sulfide (LPS), or lithium phosphorus sulfur chloride (LPSCl), or any one of combinations thereof. The polymer solid electrolyte material may include a solvent-free solid electrolyte material or a gel solid electrolyte material.

The electrode active material may include a secondary battery electrode active material and may include a lithium secondary battery electrode active material. The electrode active material may include a positive electrode active material and/or a negative electrode active material. The positive electrode active material may include, for example, sulfur, LiCoO₂, LiNiO, LiNiₓCo_{y}Mn_{1-x-y}O, LiMnO₄, or LiFePO₄, or any one of mixtures thereof. The negative electrode active material may include silicon, tin, graphite, or lithium, or any one of mixtures thereof.

The preparing of a coating mixture may include mixing about 52.6 to about 98.5 parts by weight of the electrode active material with respect to 100 parts by weight of a total of the binder, the solid electrolyte material, and the electrode active material. In this case, the binder may be a concept excluding the weight of a solvent from the binder solution. The preparing of a coating mixture may include mixing about 1 to about 42.1 parts by weight of the solid electrolyte material with respect to 100 parts by weight of a total of the binder, the solid electrolyte material, and the electrode active material. The preparing of a coating mixture may include mixing about 0.5 to about 5.3 parts by weight of the binder with respect to 100 parts by weight of a total of the binder, the solid electrolyte material, and the electrode active material.

The preparing of a coating mixture (S12) may further include mixing the binder solution, the solid electrolyte material, and the electrode active material with a second solvent. The binder solution, the solid electrolyte material, and the electrode active material may be mixed with the second solvent and stirred to form a slurry. For example, the second solvent may include the same material as the first solvent, and the second solvent may include anisole. For example, the mixing of the binder solution with the solid electrolyte material and the electrode active material, and the mixing of the binder solution, the solid electrolyte material, and the electrode active material with the second solvent may be performed concurrently, but are not limited in sequence in time.

The preparing of a coating mixture (S12) may further include mixing the binder solution, the solid electrolyte material, and the electrode active material with a conductive material. For example, the conductive material may include carbon black, carbon nanotube, or graphene, or any one of combinations thereof. For example, the mixing of the binder solution with the solid electrolyte material and the electrode active material, and the mixing of the binder solution, the solid electrolyte material, and the electrode active material with the conductive material may be performed concurrently, but are not limited in sequence in time.

The preparing of a coating mixture may include mixing about 50 to about 98.5 parts by weight of the electrode active material with respect to 100 parts by weight of a total of the binder, the solid electrolyte material, the electrode active material, and the conductive material. In this case, the binder may be a concept excluding the weight of a solvent from the binder solution. The preparing of a coating mixture may include mixing about 1 to about 40 parts by weight of the solid electrolyte material with respect to 100 parts by weight of a total of the binder, the solid electrolyte material, the electrode active material, and the conductive material. The preparing of a coating mixture may include mixing about 0.5 to about 5 parts by weight of the binder with respect to 100 parts by weight of a total of the binder, the solid electrolyte material, the electrode active material, and the conductive material. The preparing of a coating mixture may include mixing greater than about 0 to about 5 parts by weight of the binder with respect to 100 parts by weight of a total of the binder, the solid electrolyte material, the electrode active material, and the conductive material.

The coating mixture may be applied onto a current collector to prepare a coating layer (S13). The current collector may include a metal such as nickel.

The forming of a coating layer may include applying the resulting product of the preparing of a coating mixture (S12) onto a current collector. For example, the result of the preparing of a coating mixture (S12) may be in the form of a slurry mixed with a second solvent.

In the method for manufacturing an electrode for an all-solid-state battery (S10) according to some embodiment of the inventive concept, a binder solution including a binder containing an acrylonitrile-butadiene rubber in an amount of about 31 to about 35 parts by weight with respect to 100 parts by weight of the acrylonitrile-butadiene rubber, and a solvent including anisole. By allowing the solvent to include anisole suitable for an acrylonitrile-butadiene rubber binder having a polar acrylic group, and allowing the binder to include an acrylonitrile-butadiene rubber in an amount of about 31 to about 35 parts by weight suitable for anisole, a binder solution having a suitable average domain size and a suitable viscosity may be prepared. Accordingly, an electrode for an all-solid-state battery exhibiting excellent mechanical properties may be manufactured.

FIG. 6 shows a method for manufacturing an all-solid-state battery according to some embodiments of the inventive concept.

Referring to FIG. 6, a method for manufacturing an all-solid-state battery according to some embodiments of the inventive concept (S1) may include forming a first electrode (S10), attaching the first electrode to one surface of a solid electrolyte (S20), and attaching a second electrode to the other surface of the solid electrolyte (S30).

The forming of a first electrode (S10) is the same as described for the method for manufacturing an electrode for an all-solid-state battery (S10) in FIG. 5.

After the forming of a first electrode (S10), the first electrode may be attached to one surface of the solid electrolyte (S20). The solid electrolyte material may include a NASICON-based solid electrolyte material, an oxide-based solid electrolyte material, a sulfide-based solid electrolyte material, or a polymer-based solid electrolyte material, or any one of combinations thereof. For example, the solid electrolyte may include the same material as the solid electrolyte material included in the first electrode.

A second electrode may be attached to the other surface of the solid electrolyte (S30). The other surface of the solid electrolyte may oppose one surface of the solid electrolyte to which the first electrode is attached. The second electrode may be spaced apart from the first electrode. When the first electrode is a positive electrode, the second electrode may be a negative electrode, and when the first electrode is a negative electrode, the second electrode may be a positive electrode. The configuration of the second electrode may be the same as or different from the configuration of the electrode for an all-solid-state battery in FIG. 5.

The method for manufacturing an all-solid-state battery according to some embodiments of the inventive concept (S1) may include a binder solution including a binder containing an acrylonitrile-butadiene rubber in an amount of about 31 to about 35 parts by weight with respect to 100 parts by weight of the acrylonitrile-butadiene rubber, and a solvent including anisole. By allowing the solvent to include anisole suitable for an acrylonitrile-butadiene rubber binder having a polar acrylic group, and allowing the binder to include an acrylonitrile-butadiene rubber in an amount of about 31 to about 35 parts by weight suitable for anisole, a binder solution having a suitable average domain size and a suitable viscosity may be prepared. Accordingly, an all-solid-state battery exhibiting excellent initial implementation capacity and lifespan may be manufactured.

Hereinafter, the effects of the inventive concept will be described through Examples, Comparative Examples, and Experimental Examples, but embodiments of the inventive concept are not limited thereto.

### [Binder Solution]

### Example 1

An acrylonitrile-butadiene rubber (binder) formed of 33 wt % of acrylonitrile units and 67 wt % of butadiene units was dissolved in an anisole solvent. The content of the acrylonitrile-butadiene rubber was 5 wt % with respect to a total weight of the solution.

### Comparative Example 1-1

A binder solution was prepared in the same manner as in <Example 1>, except that a toluene solvent instead of the anisole solvent was used.

### Comparative Example 1-2

A binder solution was prepared in the same manner as in <Example 1>, except that a xylene solvent instead of the anisole solvent was used.

### Comparative Example 1-3

A binder solution was prepared in the same manner as in <Example 1>, except that an acrylonitrile-butadiene rubber formed of 29 wt % of acrylonitrile units and 71 wt % of butadiene units was used instead of the acrylonitrile-butadiene rubber formed of 33 wt % of acrylonitrile units and 67 wt % of butadiene units.

### Comparative Example 1-4

A binder solution was prepared in the same manner as in <Example 1>, except that an acrylonitrile-butadiene rubber formed of 37 wt % of acrylonitrile units and 63 wt % of butadiene units was used instead of the acrylonitrile-butadiene rubber formed of 33 wt % of acrylonitrile units and 67 wt % of butadiene units.

### <Experimental Example 1-1> Visual Observation

Binder solutions of <Example 1>, <Comparative Example 1-1>, and <Comparative Example 1-2> were observed visually. [Table 1] shows the results of visually observing the binder solutions of <Example 1>, <Comparative Example 1-1>, and <Comparative Example 1-2>.

TABLE 1

| | Results of visual observation |
|---|---|
| <Example 1> | Transparency |
| <Comparative Example 1-1> | Slightly opaque white |
| <Comparative Example 1-2> | Opaque white |

The visual observation of the binder solutions of <Example 1>, <Comparative Example 1-1>, and <Comparative Example 1-2> shows that <Example 1> was transparent, while <Comparative Example 1-1> was slightly opaque white and <Comparative Example 1-2> was highly opaque white. It was observed that <Example 1> was significantly more transparent than <Comparative Example 1-1> and <Comparative Example 1-2>, which is attributed to a domain size of polymers and entanglement between polymers, which will be described later.

### <Experimental Example 1-2> Measurement of Domain Size

In the binder solutions of <Example 1>, <Comparative Example 1-1>, and <Comparative Example 1-2>, a domain size of acrylonitrile-butadiene rubber was measured.

Specifically, the domain size was measured using dynamic light scattering (DLS). A 660 nm laser was passed through each of the binder solutions of <Example 1>, <Comparative Example 1-1>, and <Comparative Example 1-2> to measure the changing scattered light of the acrylonitrile-butadiene rubber so as to determine the domain size using the Stokes-Einstein Equation.

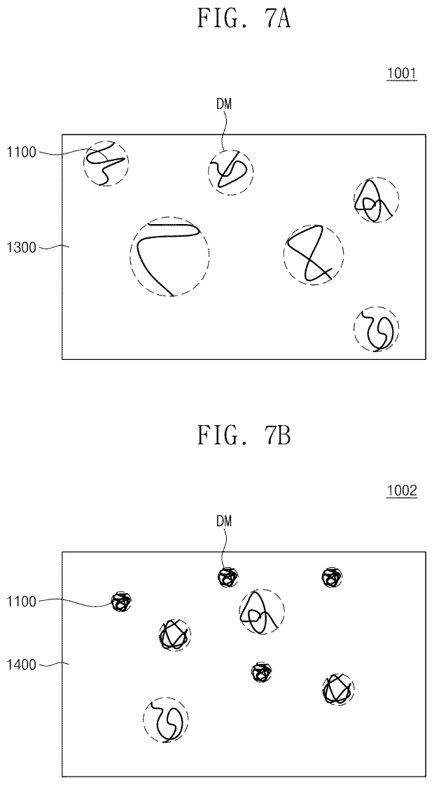

FIG. 7A is a schematic view of a binder solution according to <Comparative Example 1-1>. FIG. 7B is a schematic view of a binder solution according to <Comparative Example 1-2>. FIG. 7 and [Table 2] show an average domain size of <Example 1>, <Comparative Example 1-1>, and <Comparative Example 1-2>.

TABLE 2

| | Average domain size (μm) |
|---|---|
| <Example 1> | 60.5 |
| <Comparative Example 1-1> | 6.2 |
| <Comparative Example 1-2> | 2.4 |

Referring to FIGS. 7A and 7B together with FIG. 1, it was observed that a domain size DM of the binder solution according to <Example> was large, and relatively, a binder 1100 was dissolved in an anisole solvent 1200. Conversely, it is determined that a domain size DM of the binder solutions according to <Comparative Example 1-1> and <Comparative Example 1-2> is small, and relatively, a binder 1100 is aggregated in a toluene solvent 1300 and a xylene solvent 1400.

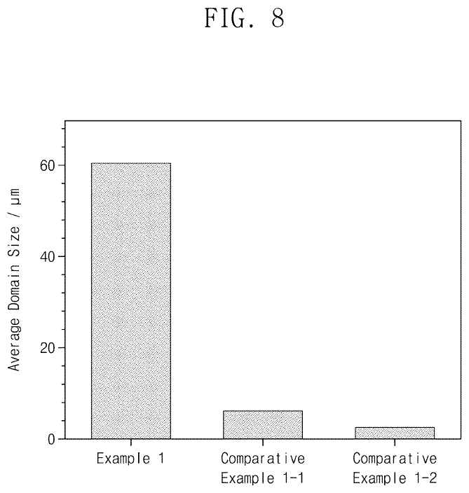

Referring to FIG. 8 and [Table 2], it is determined that an average domain size (μm) of the binder solution is larger in the order of <Experimental Example 1>, <Comparative Example 1-1>, and <Comparative Example 1-2>, as in the case of <Experimental Example 1-1>, FIG. 1, FIG. 7A, and FIG. 7B.

### <Experimental Example 1-3> Measurement of Viscosity

A viscosity of binder solutions of <Example 1>, <Comparative Example 1-1>, and <Comparative Example 1-2> was measured.

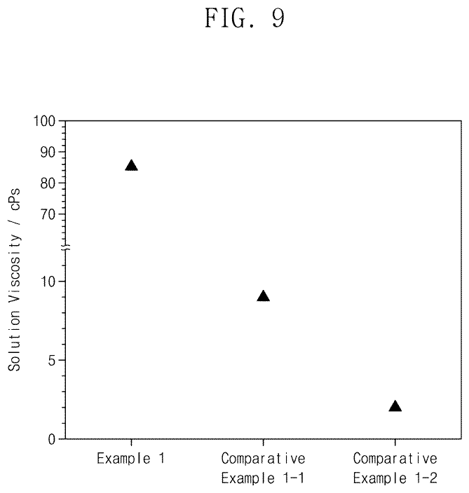

FIG. 9 and [Table 3] show a viscosity of binder solutions of <Example 1>, <Comparative Example 1-1>, and <Comparative Example 1-2>.

TABLE 3

| | Viscosity (cPs) |
|---|---|
| <Example 1> | 85 |
| <Comparative Example 1-1> | 9 |
| <Comparative Example 1-2> | 2 |

Referring to FIG. 9 and [Table 3], it is determined that viscosity (cPs) is greater in the order of <Example 1>, <Comparative Example 1-1>, and <Comparative Example 1-2> depending on the type of solvent, despite the same content of acrylonitrile-butadiene rubber. This is a result consistent with the domain size (μm), and may be analyzed as being attributable to the binder in <Example 1> being more dissolved in the solvent compared to <Comparative Example 1-1> and <Comparative Example 1-2>.

[Electrode for all-Solid-State Battery]

### Example 2

An electrode for an all-solid-state battery according to FIG. 2 was manufactured.

Specifically, natural graphite and nano-sized silicon were used as electrode active materials, and lithium phosphorus sulfur chloride (LPSCl) was used as a solid electrolyte material.

The electrode active material, the solid electrolyte material, and the binder solution of <Example 1> were mixed. Specifically, 70 parts by weight of the electrode active material, 28 parts by weight of the solid electrolyte material, and 2 parts by weight of the binder were mixed with respect to 100 parts by weight of a total of the electrode active material, the solid electrolyte material, and the binder. In particular, 63 parts by weight of natural graphite and 7 parts by weight of nano-sized silicon were mixed. The mixture was stirred in an anisole solvent to prepare a slurry. A nickel current collector was used as a current collector, and the prepared slurry was applied onto the current collector and then dried to prepare a 45 μm thick negative electrode.

### Comparative Example 2-1

A negative electrode was manufactured in the same manner as in <Example 2>, except that (1) the binder solution of <Comparative Example 1-1> was used instead of the binder solution of <Example 1>, and (2) a toluene solvent was used instead of the anisole solvent of <Example 2>.

### Comparative Example 2-2

A negative electrode was manufactured in the same manner as in <Example 2>, except that (1) the binder solution of <Comparative Example 1-2> was used instead of the binder solution of <Example 1>, and (2) a xylene solvent was used instead of the anisole solvent of <Example 2>.

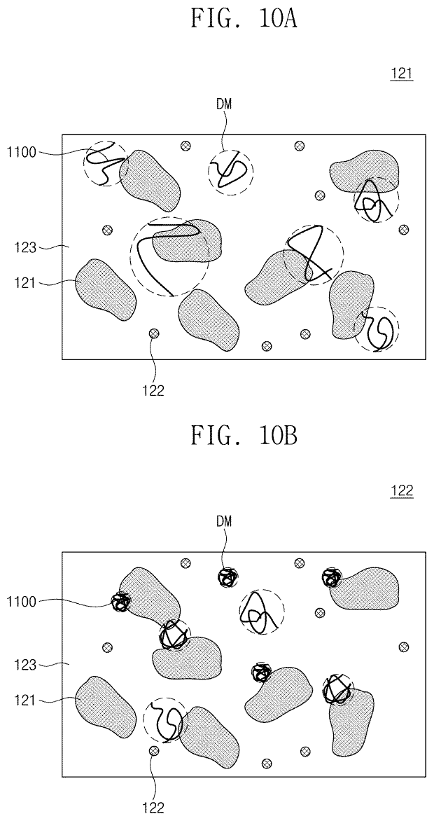

FIG. 10A is a plan view of a coating layer of an electrode for an all-solid-state battery according to <Comparative Example 2-1>. FIG. 10B is a plan view of a coating layer of an electrode for an all-solid-state battery according to <Comparative Example 2-2>.

Referring to FIGS. 10A and 10B together with FIGS. 3, 7A, 7B, and 1, it is determined that the domain size of the acrylonitrile-butadiene rubber in the binder solution is maintained in the manufactured electrode. That is, it is determined that the binder of the negative electrode of <Example 2> is better dissolved in the coating layer than the binders of the negative electrodes of <Comparative Example 2-1> and <Comparative Example 2-2>.

### <Experimental Example 2> Measurement of Peel Strength of Electrode

Peel strength was measured for electrodes of <Example 2>, <Comparative Example 2-1>, and <Comparative Example 2-2>.

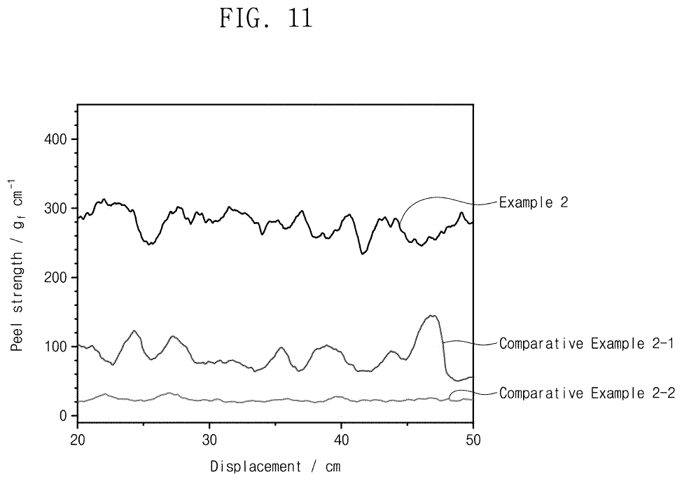

FIG. 11 shows the results of measuring peel strength of electrodes according to <Example 2>, <Comparative Example 2-1>, and <Comparative Example 2-2>. [Table 4] shows average peel strength (gf/cm) values derived from FIG. 11.

TABLE 4

| | Average peel strength (gf/cm) |
|---|---|
| <Example 2> | 278 |
| <Comparative Example 2-1> | 86 |
| <Comparative Example 2-2> | 23 |

Referring to FIG. 11 and [Table 4], it is determined that <Example 2> has a better peel strength of the negative electrode than <Comparative Example 2-1> and <Comparative Example 2-2>.

### [Solid Electrolyte Film]

A solid electrolyte film having a configuration similar to that in FIG. 2 was manufactured. Herein, the solid electrolyte film may indicate a configuration similar to that in FIG. 2, but with the electrode active material excluded from the coating layer 120 of FIG. 2.

### Example 3

A solid electrolyte film having a similar configuration to that of FIG. 2 was manufactured.

Specifically, lithium phosphorus sulfur chloride (LPSCl) was used as a solid electrolyte material.

The solid electrolyte material and the binder solution of <Example 1> were mixed. Specifically, 98 parts by weight of the solid electrolyte material and 2 parts by weight of the binder were mixed with respect to 100 parts by weight of a total of the solid electrolyte material and the binder. The mixture was stirred in an anisole solvent to prepare a slurry. A nickel current collector was used as the current collector, and the prepared slurry was applied onto the current collector and then dried.

### Comparative Example 3-1

A solid electrolyte film was manufactured in the same manner as in <Example 3>, except that (1) the binder solution of <Comparative Example 1-3> was used instead of the binder solution of <Example 1>, and (2) a toluene solvent was used instead of the anisole solvent of <Example 3>.

### Comparative Example 3-2

A solid electrolyte film was manufactured in the same manner as in <Example 3>, except that (1) the binder solution of <Comparative Example 1-4> was used instead of the binder solution of <Example 1>, and (2) a xylene solvent was used instead of the anisole solvent of <Example 3>.

### <Experimental Example 3> Measurement of Peel Strength of Solid Electrolyte Film

Peel strength was measured for solid electrolyte films of <Example 3>, <Comparative Example 3-1>, and <Comparative Example 3-2>.

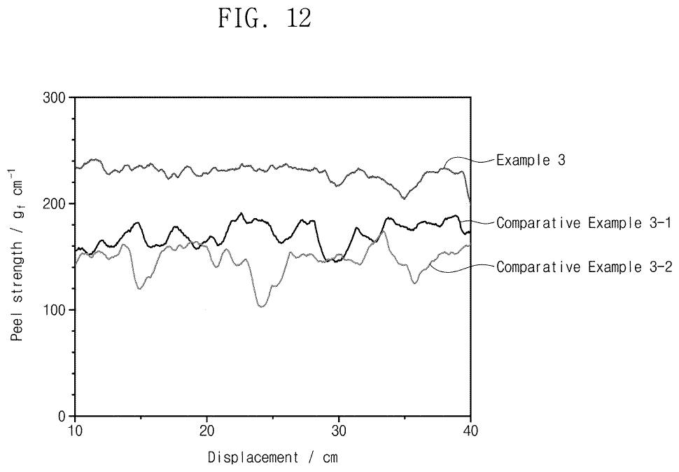

FIG. 12 shows the results of measuring peel strength of electrodes according to <Example 3>, <Comparative Example 3-1>, and <Comparative Example 3-2>. [Table 5] shows average peel strength (gf/cm) values derived from FIG. 12.

TABLE 5

| | Peel strength (gf/cm) |
|---|---|
| <Example 3> | 229 |
| <Comparative Example 3-1> | 170 |
| <Comparative Example 3-2> | 146 |

Referring to FIG. 12 and [Table 5], it is determined that <Example 3> has a better peel strength of the solid electrolyte film than <Comparative Example 3-1> and <Comparative Example 3-2>.

[all-Solid-State Battery]

### Example 4

An all-solid-state battery was manufactured according to FIG. 4.

Specifically, an all-solid-state battery was manufactured using an LPSCl pellet as a solid electrolyte, the negative electrode according to <Example 2> as a working electrode, and a lithium metal having a thickness of 300 μm as a counter electrode. The working electrode was attached to one surface of the solid electrolyte, and the counter electrode was attached to the other surface of the solid electrolyte.

### Comparative Example 4-1

A battery was manufactured in the same manner as in <Example 3>, except that the negative electrode according to <Comparative Example 2-1> was used as a working electrode.

### Comparative Example 4-2

A battery was manufactured in the same manner as in <Example 3>, except that the negative electrode according to <Comparative Example 2-2> was used as a working electrode.

### <Experimental Example 4-1> Battery Evaluation-1

Batteries according to <Example 4>, <Comparative Example 4-1>, and <Comparative Example 4-2> were evaluated at an external pressure of about 48 MPa. The batteries were charged and discharged for 3 cycles at 0.15 C, 3 cycles at 0.3 C, 3 cycles at 0.75 C, 3 cycles at 1.5 C, and 100 cycles at 0.3 C, and specific capacity was measured as an output characteristic and Coulombic efficiency was measured as a lifespan characteristic.

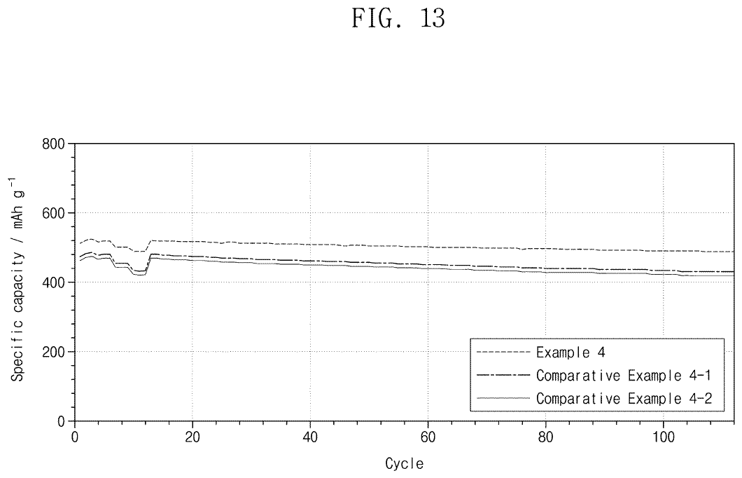

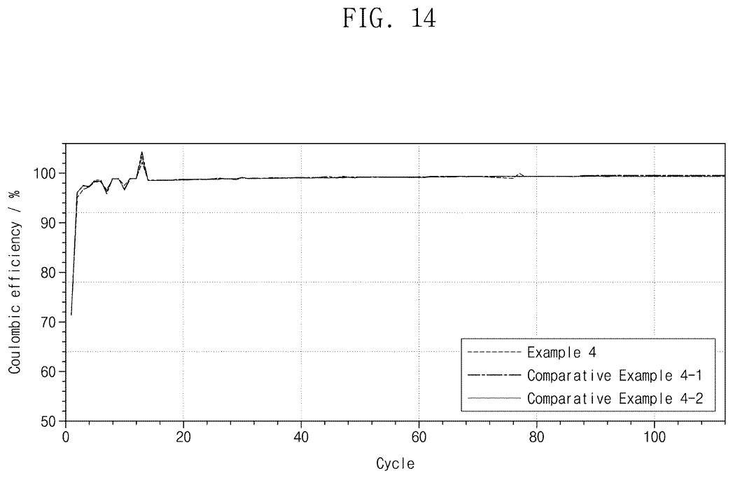

FIG. 13 shows the results of measuring specific capacity of batteries according to <Example 4>, <Comparative Example 4-1>, and <Comparative Example 4-2> at an external pressure of about 48 MPa. FIG. 14 shows the results of measuring Coulombic efficiency of batteries according to <Example 4>, <Comparative Example 4-1>, and <Comparative Example 4-2> at an external pressure of about 48 MPa.

Referring to FIGS. 13 and 14, it is determined that <Example 4> exhibits better output (specific capacity) and lifespan characteristics (Coulombic efficiency) than <Comparative Example 4-1> and <Comparative Example 4-2>.

### <Experimental Example 4-2> Battery Evaluation-2

The specific capacity and Coulombic efficiency of the batteries according to <Example 4> and <Comparative Example 4-1> were measured in the same manner as in <Experimental Example 4-1>, except that the external pressure was 12 MPa.

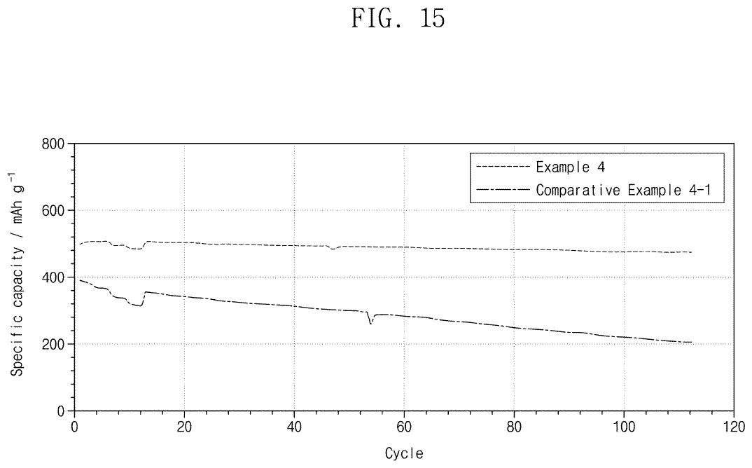

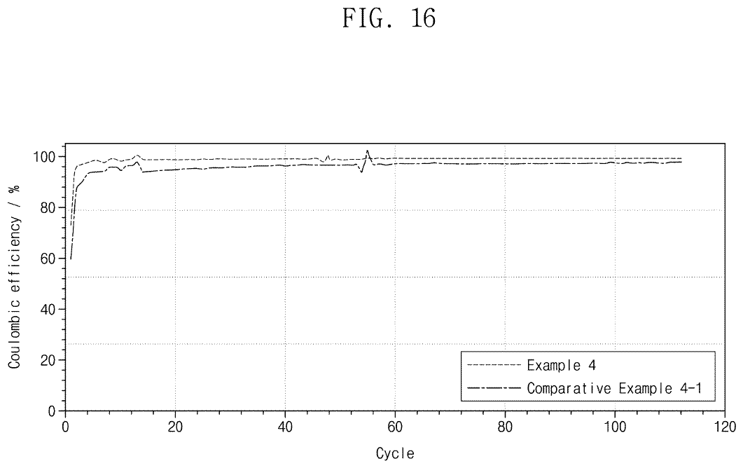

FIG. 15 shows the results of measuring specific capacity of batteries according to <Example 4>, <Comparative Example 4-1>, and <Comparative Example 4-2> at a pressure of about 12 MPa. FIG. 16 shows the results of measuring Coulombic efficiency of the batteries according to <Example 4>, <Comparative Example 4-1>, and <Comparative Example 4-2> at an external pressure of about 48 MPa.

Referring to FIGS. 15 and 16, it is determined that <Example 4> exhibits better output and lifespan characteristics than <Comparative Example 4-1> and <Comparative Example 4-2> even at low driving pressure.

### <Experimental Example 4-3> Mechano-Electrochemical Analysis

Mechano-electrochemical analysis was performed at an external pressure of 300 MPa for batteries of <Example 4>, <Comparative Example 4-1>, and <Comparative Example 4-2>. The batteries of <Example 4>, <Comparative Example 4-1>, and <Comparative Example 4-2> were charged and discharged to monitor internal pressure changes.

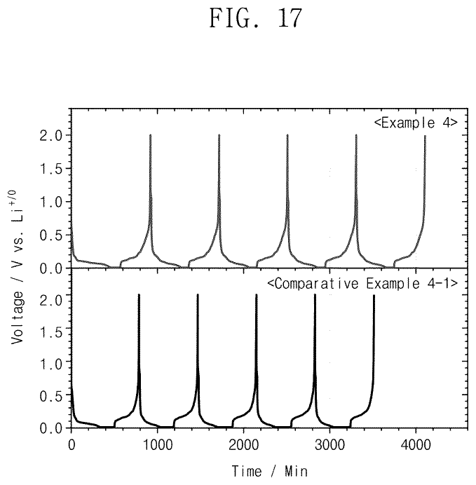

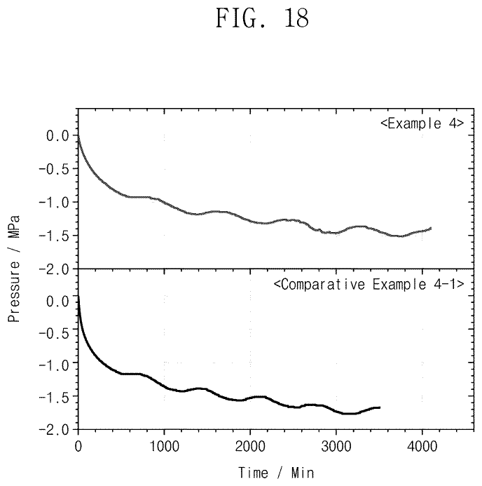

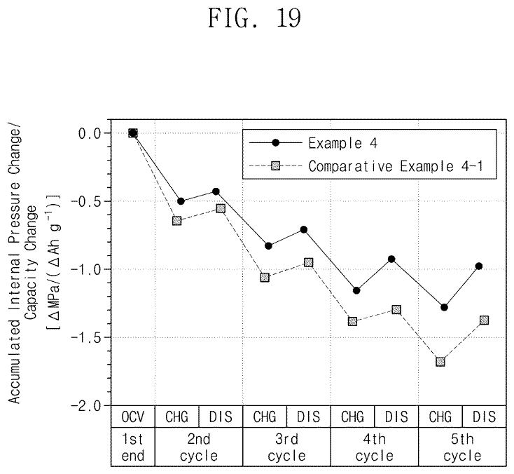

FIG. 17 shows the results of measuring voltage over time of <Experimental Example 4-3> of <Example 4>, <Comparative Example 4-1>, and <Comparative Example 4-2>. FIG. 18 shows the results of measuring internal pressure over time of <Experimental Example 4-3> of <Example 4>, <Comparative Example 4-1>, and <Comparative Example 4-2>. FIG. 19 shows accumulated internal pressure change/capacity change values according to charge and discharge of Experimental Example 4-3> of <Example 4>, <Comparative Example 4-1>, and <Comparative Example 4-2>.

Referring to FIGS. 17 to 19, it is determined that <Example 4>, unlike <Comparative Example 4-1> and <Comparative Example 4-2>, exhibits small changes in internal pressure even though despite large capacity implementation.

A binder solution for an all-solid-state battery according to the inventive concept may include a solvent containing anisole and a binder containing an acrylonitrile-butadiene rubber having a specific composition, and may thus increase a diameter of a domain size of the binder. Accordingly, a solution in which the binder is evenly distributed in the solvent may be provided.

An electrode for an all-solid-state battery and a method for manufacturing an all-solid-state battery according to the inventive concept may use a solvent containing anisole and a binder containing an acrylonitrile-butadiene rubber having a specific composition. Accordingly, an electrode for an all-solid-state battery exhibiting excellent mechanical properties and an all-solid-state battery exhibiting excellent output and lifespan characteristics may be manufactured.

The electrode for an all-solid-state battery and the all-solid-state battery according to the inventive concept may include a coating layer containing a binder having an average domain size of about 15 μm to about 110 μm. Accordingly, the electrode for an all-solid-state battery may have improved mechanical properties, and the all-solid-state battery may have improved output and lifespan characteristics.

Embodiments of the disclosure have been described with reference to the accompanying drawings. However, the disclosure may be implemented in other detailed forms without changing the technical spirit or necessary features thereof. It is therefore to be understood that the above-described embodiments are illustrative in all aspects and not restrictive.

What is claimed is:

1. A binder solution for an all-solid-state battery, comprising:
a solvent including anisole; and
a binder including an acrylonitrile-butadiene rubber containing an acrylonitrile repeating unit and a butadiene repeating unit,
wherein the acrylonitrile repeating unit amounts to 31 to 35 parts by weight with respect to 100 parts by weight of the acrylonitrile-butadiene rubber.

2. The binder solution for an all-solid-state battery of claim 1, wherein the binder amounts to 1 to 10 parts by weight with respect to 100 parts by weight of the binder solution.

3. The binder solution for an all-solid-state battery of claim 1, having a viscosity of 15 cPs to 200 cPs.

4. The binder solution for an all-solid-state battery of claim 1, wherein the acrylonitrile-butadiene rubber has a weight average molecular weight of 5,000 g/mol to 10,000,000 g/mol.

5. The binder solution for an all-solid-state battery of claim 1, wherein the binder has an average domain size of 15 μm to 110 μm.

6. A method for manufacturing an electrode for an all-solid-state battery, the method comprising:
mixing a binder with a first solvent to prepare a binder solution;
mixing the binder solution with a solid electrolyte material and an electrode active material to prepare a coating mixture; and
applying the coating mixture onto a current collector to form a coating layer,
wherein the first solvent includes anisole,
the binder includes an acrylonitrile-butadiene rubber containing an acrylonitrile repeating unit and a butadiene repeating unit, and the acrylonitrile repeating unit amounts to 31 to 35 parts by weight with respect to 100 parts by weight of the acrylonitrile-butadiene rubber.

7. The method of claim 6, wherein the solid electrolyte material comprises a sodium (Na) super ionic conductor (NASICON)-based solid electrolyte material, and
the NASICON-based solid electrolyte material comprises NASICON-type LATP (Li_{1.3}Al_{0.3}Ti_{1.7}(PO₄)₃), or NASICON-type LAGP (Li_{1.5}Al_{0.5}Ge_{1.5}(PO₄)₃), or any one of combinations thereof.

8. The method of claim 6, wherein the solid electrolyte material comprises an oxide-based solid electrolyte material, and
the oxide-based solid electrolyte material comprises Garnet structure LLZO (Li₇La₃Zr₂O₁₂), or Perovskite-type LLTO (Li_{0.3}La_{0.57}TiO₃), or any one of combinations thereof.

9. The method of claim 6, wherein the solid electrolyte material comprises a sulfide-based solid electrolyte material, and
the sulfide-based solid electrolyte material comprises lithium phosphorus sulfide (LPS), or lithium phosphorus sulfur chloride (LPSCl), or any one of combinations thereof.

10. The method of claim 6, wherein the solid electrolyte material comprises a polymer solid electrolyte material, and
the polymer solid electrolyte material comprises a solvent-free solid electrolyte material, or a gel solid electrolyte material, or any one of combinations thereof.

11. The method of claim 6, wherein the electrode active material is a negative electrode active material, and
the negative electrode active material comprises silicon, tin, graphite, or lithium, or any one of mixtures thereof.

12. The method of claim 6, wherein the electrode active material is a positive electrode active material, and
the positive electrode active material comprises sulfur, LiCoO₂, LiNiO, LiNiₓCo_{y}Mn_{1-x-y}O, LiMnO₄, or LiFePO₄, or any one of mixtures thereof.

13. The method of claim 6, wherein the acrylonitrile-butadiene rubber has a weight average molecular weight of 5,000 g/mol to 10,000,000 g/mol.

14. The method of claim 6, wherein the preparing of a coating mixture further comprises mixing the binder solution, the solid electrolyte material, and the electrode active material with a second solvent, and
the second solvent comprises anisole.

15. The method of claim 6, wherein in the preparing of a coating mixture, with respect to 100 parts by weight of a total of the binder, the solid electrolyte material, and the electrode active material,
the electrode active material amounts to 52.6 to 98.5 parts by weight,
the solid electrolyte material amounts to 1 to 42.1 parts by weight, and
the binder amounts to 0.5 to 5.3 parts by weight.

16. The method of claim 6, wherein the preparing of a coating mixture further comprises mixing the binder solution, the solid electrolyte material, and the electrode active material with a conductive material, and
the conductive material comprises carbon black, carbon nanotube, or graphene, or any one of combinations thereof.

17. The method of claim 16, wherein in the preparing of a coating mixture, with respect to 100 parts by weight of a total of the binder, the solid electrolyte, the electrode active material, and the conductive material,
the electrode active material amounts to 50 to 98.5 parts by weight,
the solid electrolyte material amounts to 1 to 40 parts by weight,
the binder amounts to 0.5 to 5 parts by weight, and
the conductive material amounts to greater than 0 to 5 parts by weight.

18. A method for manufacturing an all-solid-state battery, the method comprising:
forming a first electrode;
attaching the first electrode to one surface of a solid electrolyte; and
attaching a second electrode to the other surface of the solid electrolyte,
wherein the forming of a first electrode includes:
mixing a binder with a first solvent to prepare a binder solution;
mixing the binder solution with a solid electrolyte material and an electrode active material to prepare an electrode coating mixture; and
applying the electrode coating mixture onto a current collector to form an electrode coating layer,
the first solvent includes anisole,
the binder includes an acrylonitrile-butadiene rubber containing an acrylonitrile repeating unit and a butadiene repeating unit, and
the acrylonitrile repeating unit amounts to 31 to 35 parts by weight with respect to 100 parts by weight of the acrylonitrile-butadiene rubber.

19. The method of claim 18, wherein the solid electrolyte and the solid electrolyte material comprise the same material.

20. An all-solid-state battery comprising:
a first electrode;
a second electrode spaced apart from the first electrode; and
a solid electrolyte disposed between the first electrode and the second electrode,
wherein the first electrode includes a current collector, and a coating layer between the current collector and the solid electrolyte,
the coating layer includes a solid electrolyte material, an electrode active material, a binder, and a conductive material,
the binder includes an acrylonitrile-butadiene rubber containing an acrylonitrile repeating unit and a butadiene repeating unit,
the acrylonitrile repeating unit amounts to 31 to 35 parts by weight with respect to 100 parts by weight of the acrylonitrile-butadiene rubber, and
in the coating layer, the binder has an average domain size of 15 μm to 110 μm.
